(19) United States
(12) Patent Application Publication
(10) Pub. No.: US 2026/0080097 A1
(43) Pub. Date: Mar. 19, 2026

(54) SYSTEM AND METHOD FOR INTELLIGENT MASKING OF INFORMATION USING A MACHINE LEARNING MODEL

(71) Applicant: NICE LTD., Ra'anana (IL)

(72) Inventors: Sumit JADHWANI, Akot (IN); Avinash PATWARI, Pune (IN); Ankur AGNIHOTRI, Pune (IN)

(73) Assignee: NICE LTD., Ra'anana (IL)

(21) Appl. No.: 18/888,490

(22) Filed: Sep. 18, 2024

(51) Int. Cl. G06F 21/62

(52) U.S. Cl. CPC G06F 21/6254

(57) ABSTRACT

A system and method for automatically identifying and masking information, including: identifying, using a machine learning model, one or more tokens in an image file using one or more data items extracted from the image file and including one or more strings, and masking one or more of the identified tokens in the image file. In some embodiments, masking includes coloring locations in the image file based on extracted location information—describing boxes or polygons bounding or surrounding of the strings in the image file. Tokens identified and/or masked by some embodiments may include personally identifiable information (PII) or data, and some embodiments may determine the type of PII data for tokens or texts identified as including PII. In some embodiments, rows of text extracted from the image file may be provided to the machine learning model in a sequential manner (e.g., one row after another).

### FIELD OF THE INVENTION

The present invention relates generally to automatic text recognition and masking in image data, and more specifically to the identification and masking of sensitive information in image data using machine learning techniques.

### BACKGROUND OF THE INVENTION

The increasing prevalence of data breaches and stringent privacy regulations, such as the General Data Protection Regulation (GDPR) and California Consumer Privacy Act (CCPA), have underscored the critical need for intelligent techniques to hide Personally Identifiable Information (PII) in various forms of data. PII, which may include sensitive data such as, e.g., names, social security numbers, and financial information, is a prime target for cybercriminals. Traditional data masking methods often fall short in protecting this data, as they can be too rigid, failing to identify PII in various data formats, potentially rendering data unusable for analysis or not secure enough to prevent re-identification. There is a need for intelligent techniques for masking PII that balance the need for data utility with robust security.

### SUMMARY

A system and method for automatically identifying and masking information, which may include according to some embodiments: identifying, using a machine learning model, one or more tokens in an image file using one or more data items extracted from the image file, where the extracted data items may include one or more strings; and masking one or more of the identified tokens in the image file.

In some embodiments, masking may include coloring locations in the image file based on extracted location information—where the location information may describe boxes or polygons bounding, covering, or surrounding of the strings in the image file. Tokens identified and/or masked by some embodiments may include, for example, personally identifiable information (PII) or data, and some embodiments may determine the type of PII data for tokens or texts identified as including PII.

In some embodiments, rows or lines of text extracted from the image file may be provided to the machine learning model in a sequential manner (e.g., one row/line after another).

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows example computer systems remotely connected by a data network according to some embodiments of the invention;

FIG. 3 shows an example information flow between different components according to some embodiments of the invention;

FIG. 4 shows a high-level architecture diagram of a system for intelligent masking according to some embodiments of the invention;

FIG. 5 shows an example information flow between different components according to some embodiments of the invention;

FIG. 6 shows an example system for intelligent masking integrated with external systems and components according to some embodiments of the invention;

FIG. 7A-B shows example results of image masking according to some embodiments of the invention;

FIG. 8A-D shows example code snippets and example outputs that may be used and/or produced in some embodiments of the invention; and

FIG. 9 is a flowchart of an example method for automatically identifying and masking information according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Some embodiments of the invention may automatically identify and mask sensitive information in image data. In some embodiments, intelligent masking of information in image files may include: identifying and extracting text from an input image file or data item using optical character recognition techniques; extracting locations (which may be or may include, e.g., spatial coordinates) of the extracted text or texts in the input image; identifying or detecting PII in the extracted text, for example using a machine learning model such as for example a large language model (LLM) or generative artificial intelligence (GenAI) model, component, service or module; masking, concealing, shielding, or covering the locations or coordinates corresponding to extracted text or texts including PII data within the input image, for example using a blank color filing; and outputting, saving or storing the masked image file.

Personally Identifiable Information (PII) as used herein may refer to any data that may be used to uniquely identify an individual. This may include information such as, e.g., names, social security numbers, email addresses, phone numbers, and biometric data. PII identification may be critical for privacy protection and/or fraud prevention because its exposure or misuse can lead to identity theft, financial fraud, and other forms of personal harm. Due to its sensitivity, PII is often subject to stringent data protection regulations and practices to ensure its confidentiality and security. While some nonlimiting examples herein refer to or address PII data or “sensitive information”, different embodiments of the invention may be used in environments where texts, data, or information items of interest that do not include PII (and that may include other types of data/information that is to be shielded or masked).

A digital image, image data, or image file as used herein may refer to a computerized data structure or file containing visual information in a format that may be displayed on screens and/or printed. This may encapsulate or encompass, for example, data representing pictures, graphics, or visual content using various encoding methods to store color, brightness, and other visual details. According to some embodiments, image files may be provided or used in multiple formats, such as for example, JPEG (Joint Photographic Experts Group), PNG (Portable Network Graphics), GIF (Graphics Interchange Format), and the like. Additional or alternative formats may be used in different embodiments.

Computerized text or simply “text” as used herein may refer to a set or a plurality of strings and/or tokens which may include a plurality of characters and symbols that may form words, sentences, paragraphs, and the like. A given text may be divided into smaller units or tokens, which may be individual elements such as characters, letters, words, punctuation marks, or symbols. A “text portion” may refer to a subset of a larger text, including, e.g., of one or more strings and/or lines or rows of text that may represent a segment of the overall text or content. According to some embodiments, text, strings, tokens, and the like, may be represented as a sequence of characters encoded using standardized encoding schemes like ASCII (American Standard Code for Information Interchange) or Unicode, where each character may be mapped to a specific binary value.

When used with respect to a digital image or image file—“text”, “text portion”, “string” or “token” may for example refer to an image (e.g. in JPEG or other form or format) of a text, portion, string, or token—or to image data, part of an image or of an image file representing text, or a part of an image file from which text may be extracted.

As used herein, the “location” of a text or text portion may refer to spatial coordinates or boundaries that may define where the text appears, e.g., within a digital image or image file. According to some embodiments, a given location or coordinates may be represented using a bounding box or a polygon. A bounding box or polygon may be a frame of a specific shape (such as, e.g., rectangular) that encloses or that surrounds the text, and may be defined by various parameters or dimensions, such as, e.g., its top-left and bottom-right corners. In some embodiments, identifying or detecting locations of texts or text portions within a digital image may be performed using appropriate optical character recognition techniques.

“Masking” or “shielding” as used herein may be or may refer covering or coloring specific parts of an image, and/to removing a relevant image portion from an image file, and/or to blacking out a relevant image portion. This may include altering the image file so that the relevant portion has its data altered, e.g. by changing a color (coloring), blacking-out or removing data, etc. A mask or shield according to some embodiments may be, e.g., a binary or color layer or matrix that may be applied to an image file (or, in some embodiments, to an image file in binary format) using, e.g., element-wise matrix multiplication—where the mask may be overlaid on the image, and each in the image pixel (which may be, e.g., an element in a matrix representing or describing the image) may multiplied by a corresponding pixel value in the mask. A masking or shielding operation may modify the image based on the mask's values or elements, with the mask determining which pixels remain unchanged (e.g., pixels for which the matrix representing the mask assigns a binary value of 1 or “white”) and which are set to a specified value or become transparent (e.g., pixels for which the matrix representing the mask assigns a binary value of 0 or “black”). Masking or shielding image files according to some embodiments of the invention may include or involve converting a digital image or image file (such as, e.g., a JPEG file) into binary format (such as for example an uncompressed binary file including raw pixel values without any compression or encoding)—which may, e.g., assist or simplify image masking for example by reducing the image to two distinct values, which may represent areas to keep visible and areas to hide or modify.

Existing data security and masking systems and methods (such as for example methods involving manual masking) may fail to identify and/or mask sensitive information such as for example personally identifiable information (PII) in image data or digital image files—which may introduce various security risks, such as for example exposing sensitive employee and customer data if breached (including, e.g., email addresses, phone numbers, financial details, account numbers, etc.) and may lead to failure to comply with security policies, regulations and standards, such as, e.g., the General Data Protection Regulation (GDPR), the California Consumer Privacy Act (CCPA), the Health Insurance Portability and Accountability Act (HIPAA), and the like.

Some embodiments of the invention may improve data security and masking technologies by introducing an LLM-based approach for intelligent, context-aware, automatic identification of PII data, which may result in accurate and robust detection of sensitive information in image files (also referred to as “digital images”), while providing a fine-grained representation of text in image data (including, e.g., token/string, or line/row locations, coordinates, and the like) which may allow for greater control and deeper understanding of image/text data (and allowing for, e.g., identification of PII data such as addresses and/or names in or across multiple lines of text), and for intelligently and automatically identifying, detecting and extracting text as well as its location in a given image file. “Context awareness” may refer to, e.g., using or considering information outside of the PII data itself to detect PII. For example, some embodiments of the invention may be able to identify, discover or detect that a field or entry “XYZ” corresponds to PII based on text found next to “XYZ”, such as for example a token or word “Password” in “Password: XYZ”. By using a machine learning model or LLM such as, e.g., described herein, some embodiments may recognize that “XYZ” corresponds to PII based on words or tokens found in its proximity, which may be referred to as “context”or “context information”.

Some nonlimiting examples for technology improvements, advantages, features, or benefits that may be provided or achieved by masking, shielding or concealing data according to some embodiments may include:
Data privacy compliance: data privacy and protection are paramount in the present day's regulatory landscape. By masking, shielding, or concealing sensitive information, for example, in customer video calls, recordings, and the like, organizations may ensure compliance with data protection regulations such as, e.g., GDPR, HIPAA, or CCPA. Avoiding data breaches and unauthorized access may help avoid significant risks.
User/customer trust and confidence: masking sensitive data may demonstrate a commitment to safeguarding user/customer information. Customers are more likely to trust an organization that takes proactive measures to protect their personal or sensitive data, which may lead to or enable sustainable customer relationships.
Mitigating insider threats: even within an organization, not all members, parties, or employees may require or may be allowed access to sensitive customer data. Masking sensitive information may further restrict or limit access to sensitive data—and may for example allow access only to parties who genuinely need it, reducing the risk of internal data breaches and unauthorized use of customer data.
Data analytics and insights: masking sensitive data may allow organizations to use user/customer videos or video call recordings as part of valuable data analytics and related processes. The organization may still derive insights and/or trends using masked data, enabling informed decision-making and process improvements without compromising privacy or introducing privacy risks or threats.
   Additional or alternative advantages, features, or benefits may be provided by different embodiments.

A “row-wise representation” or “line-wise representation” as used herein may refer to text or string data structured line-by-line, with each line representing a separate portion of the overall text or content. In this format, text or string data (such as for example text or text portions that may be identified digital image file) may be extracted and/or processed and/or arranged in rows, e.g., for easier sequential access and analysis. For instance, given the following example text:
Good morning, Mister Benson
I see you're doing well
   Some embodiments of the invention may generate, extract, or process the text using the following a row- or line-wise representation:
1) Good morning, Mister Benson
2) I see you're doing well
   Where 1) and 2) may be separate data items or files that may, e.g., be provided or be input separately and/or sequentially into a machine learning model, generative artificial intelligence model, or large language model. Additional or alternative text representations may be used in different embodiments.

Some embodiments of the invention may include, e.g., the following nonlimiting example operations:
Extracting text from input images using an optical character recognition (OCR) component of module (such as, e.g., the artificial intelligence (AI) based OCR engine by Microsoft Azure).
Data preparation—creating, generating, or processing a row-wise representation of text portions, string or token data (where, e.g., a plurality of data items may be created to include one or more rows or lines of text extracted from the image file or digital image) that may be used for better contextual understanding.
Identification of PII data in the row-wise representation of the text, e.g., using a machine learning model (such as for example an LLM or GenAI component, service or module).
Masking, shielding, or covering sensitive data, e.g., using a dedicated algorithm, program, or module (and using, e.g., a dedicated library for the Python programming language).
   Additional or alternative operations may be used or included in different embodiments.

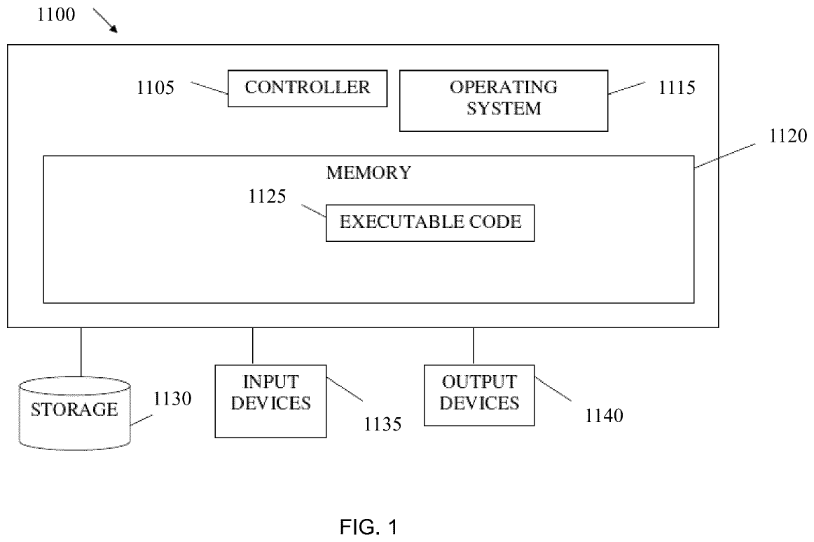

FIG. 1 shows a high-level block diagram of an exemplary computing device which may be used with embodiments of the present invention. Computing device 1100 may include a controller or computer processor 1105 that may be, for example, a central processing unit processor (CPU), a chip or any suitable computing device, an operating system 1115, a memory 1120, a storage 1130, input devices 135 and output devices 140 such as a computer display or monitor displaying for example a computer desktop system.

Operating system 1115 may be or may include code to perform tasks involving coordination, scheduling, arbitration, or managing operation of computing device 1100, for example, scheduling execution of programs. Memory 1120 may be or may include, for example, a Random Access Memory (RAM), a read only memory (ROM), a Flash memory, a volatile or non-volatile memory, or other suitable memory units or storage units. Memory 1120 may be or may include a plurality of different memory units. Memory 1120 may store for example, instructions (e.g. code 1125) to carry out a method as disclosed herein, and/or output data, etc.

Executable code 1125 may be any application, program, process, task, or script. Executable code 1125 may be executed by controller 1105 possibly under control of operating system 1115. For example, executable code 1125 may be or execute one or more applications performing methods as disclosed herein. In some embodiments, more than one computing device 1100 or components of device 1100 may be used. One or more processor(s) 1105 may be configured to carry out embodiments of the present invention by for example executing software or code. Storage 1130 may be or may include, for example, a hard disk drive, a floppy disk drive, a compact disk (CD) drive, a universal serial bus (USB) device or other suitable removable and/or fixed storage unit. Data described herein may be stored in a storage 1130 and may be loaded from storage 1130 into a memory 1120 where it may be processed by controller 1105.

Input devices 1135 may be or may include a mouse, a keyboard, a touch screen or pad or any suitable input device or combination of devices. Output devices 1140 may include one or more displays, speakers and/or any other suitable output devices or combination of output devices. Any applicable input/output (I/O) devices may be connected to computing device 1100, for example, a wired or wireless network interface card (NIC), a modem, printer, a universal serial bus (USB) device or external hard drive may be included in input devices 1135 and/or output devices 1140.

Embodiments of the invention may include one or more article(s) (e.g. memory 1120 or storage 1130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

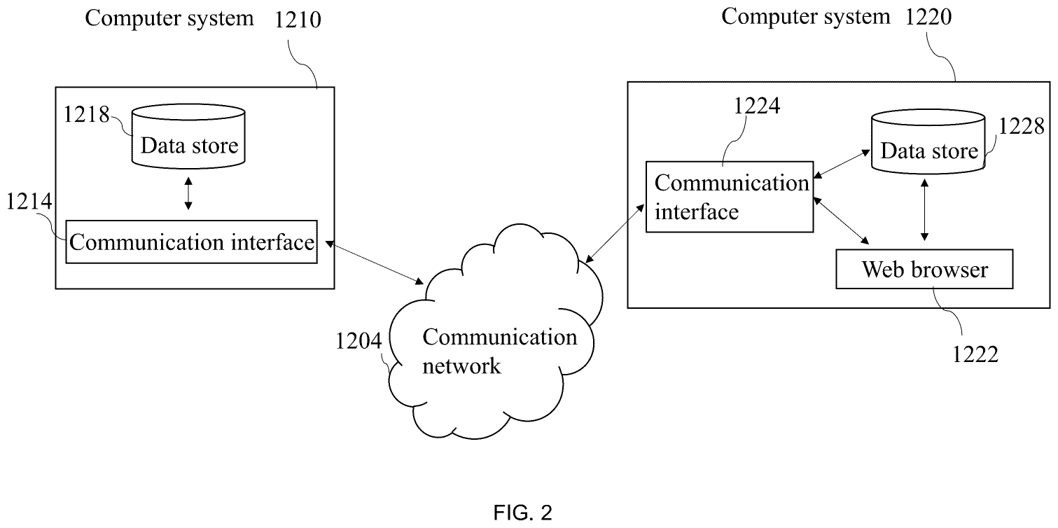

FIG. 2 shows example computer systems remotely connected by a data network according to some embodiments of the invention.

Some embodiments of the invention may include performing an exchange of data or data transfer between remotely connected computer devices. For example, remote computer 1210 may send or transmit, over communication or data network 1204, computerized data items, data elements, or data points of information (such as for example input digital image files, output or masked images, LLM or GenAI prompts, and the like)—to computerized system 1220, and/or vice versa. Each of systems 1210 and 1220 may be or may include the various components described with reference to system 1100, as well as other computer systems, and include and/or operate or perform, e.g., the various corresponding protocols and procedures described herein. In some embodiments, computerized systems 1210 and 1220 may additionally perform a plurality of operations including for example sending and/or transmitting and/or collecting and/or receiving additional data to or from additional remote computers systems. One skilled in the art may recognize that additional and/or alternative remote and/or computerized systems and/or network and connectivity types may be included in different embodiments of the invention.

In some embodiments of the invention, computer systems 1210 and 1220 may communicate via data or communication or data network 1204 via appropriate communication interfaces 1214 and 1224, respectively—which may be for example NICs or network adapters as known in the art. Computerized systems 1210 and/or 1220 may include data stores such as, e.g., 1218 and 1228 which may for example include a plurality of received data items, messages, requests, reports, and the like, such as for example described herein.

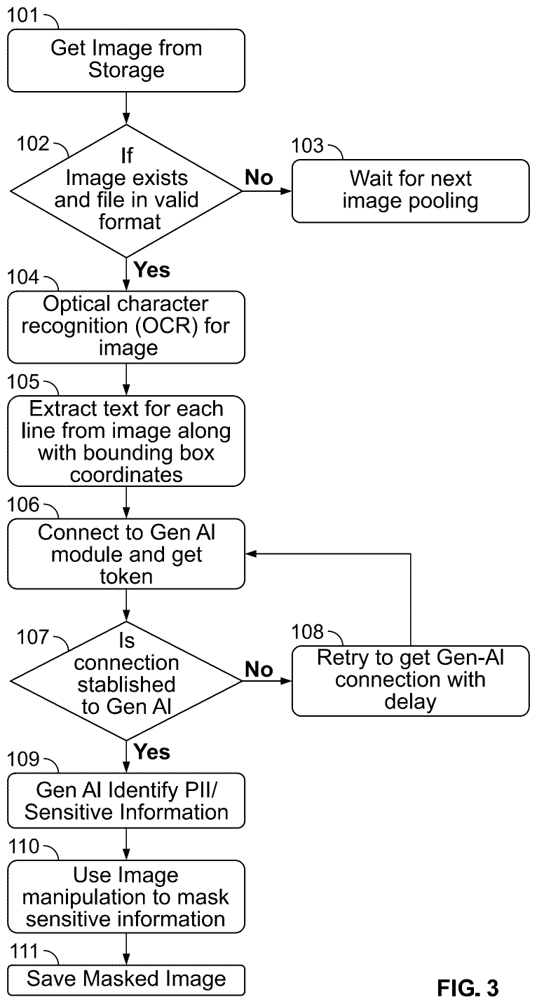

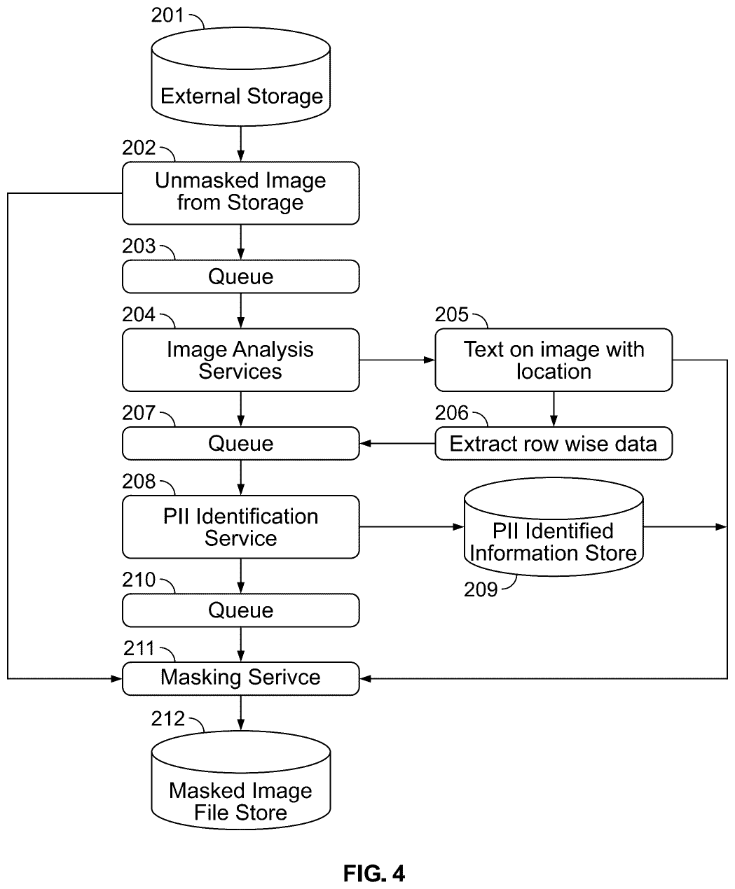

FIG. 3 shows an example information flow between different components according to some embodiments of the invention.

A queuing system as used herein may refer to a mechanism used to manage and process tasks or requests in a controlled, orderly manner. It may include or represent a queue where incoming tasks or data items (such as for example row- or line-wise data items to be input into an LLM) may be stored and processed sequentially by one or more workers or servers. This system may help in managing computerized workloads, balancing computerized resource utilization, and preventing bottlenecks by ensuring that tasks are handled efficiently (which may be needed in in environments with limited processing capacity or high traffic, such as for example web servers or distributed systems). Some nonlimiting example queuing systems or components that may be used in some embodiments of the invention may include, e.g., the Simple Queue Service (SQS) provided as part of the Amazon Web Services (AWS) cloud computing platform, although additional of alternative systems or components may be used in different embodiments.

A “big data connection” as used herein may refer establishing a data pipeline or integration that allows for the transfer, access, and analysis of large-scale data sets between systems, platforms, or databases. This may involve, in some embodiments, connecting to distributed storage systems (such as, e.g., the Hadoop, AWS S3 systems) or big data processing frameworks (such as, e.g., the Apache Spark framework) to handle high-volume, high-velocity, and high-variety data in real time or batch processing environments. These connections may ensure the efficient movement and accessibility of massive amounts of data for analytics and machine learning. According to some embodiments, establishing a big data connection may involve validating a key or validation token, e.g., to ensure secure and authorized access to sensitive or distributed data systems. This validation process may involve checking the key or validation token against an authentication server to confirm its legitimacy and permissions, ensuring that only authorized systems, parties, or clients can access or manipulate data. Additional or alternative nonlimiting example systems and/or frameworks may be used in different embodiments.

Example elements and/or operations of FIG. 3 are described in Table 1:
101 This may represent a queuing system or mechanism to get or fetch images from a database or external system.
102 This may represent a module or component where the fetched images may be checked or tested, which may include, e.g., checking if images or digital image files are present and if so—validate or check if images are in a desirable, or correct/incorrect format.
103 This may include, if images are not present, fetching or polling (e.g., periodically, such as for example once in 10 minutes) to get any new images from the queue/external database.
104 This may be or may represent a logical block and/or module in which image data may be converted into text (which may correspond to a plurality of strings, portions of text or “text portions”, and/or tokens) using optical character recognition (OCR). Also, this may return or output the text on image along with its location or coordinates in the image file or data structure (see nonlimiting examples herein).
105 This may be a logical block and/or module in which line- or row-wise data items (where, e.g., each data item may include one or more rows or lines of text extracted from the digital image file) may be extracted along with its coordinates.
106 This may represent a network or big data connection mechanism to connect to generative AI system to get a required key or validation token after authentication.
107 In this operation, connection may be successful, e.g., by validating the key or token.
108 This may be a “Retry” mechanism, e.g., in case of an invalid key or token and/or unsuccessful connection to the GenAI component or system.
109 This may represent or may be a logical block and/or module which may take or receive row-wise text extracted from the relevant image or file as input, e.g., along with their location as data items (e.g., using a queuing system). Here, GenAI may be used to identify or detect PII from given text, find or use its location information from the provided input data, and return or output meaningful information, e.g., in the following example format:
   “Line”: “XXXXX”, “Type”: “Full Name”, “Bounding Box”: [{‘x’:1559, ‘y’:23}, {‘x’:1402, ‘y’:22}, {‘x’:1559, ‘y’:45}, {‘x’:1402, ‘y’:44}]
   which may be returned or output for example as a JSON array.
   (Where, e.g., XXXXX may be the text or portion included in a given line or row)
110 This may represent or may be a logical block and/or module including or corresponding to image masking. Here, the original image may be altered or masked in a location received and corresponding to PII data. Parts which may include sensitive data or information may be replaced with a color mask.
111 This may be the final step where a masked image may be stored back in the system, e.g., for further analytical operations and consumption.

### Table 1

Additional or alternative components and/or operations and/or data formats may be used in different embodiments of the invention.

FIG. 4 shows a high-level architecture diagram of a system for intelligent masking according to some embodiments of the invention.

Example elements and/or operations of FIG. 4 are described in Table 2:
201 This may represent a queue or queuing system or other equivalent mechanism to get or fetch images or digital image files from an external system or systems.
202 Fetched images may be pulled into or stored in local storage for further processing.
203 This may represent a queue mechanism where raw (or pre-masked) images or digital image files may be fetched or received for processing.
204 This may represent a logical or module or optical character recognition or natural language processing model component or module which may run optical character recognition (OCR) on an input image and output text (e.g., text portions, strings and/or tokens) along with location information or coordinates within the input image.
205 This may represent a logical block and/or module where text along with location information may be fetched from the OCR module or service.
206 This may represent a logical block and/or module in which row-wise data or data items (where, e.g., each data item may include one or more rows or line of text extracted from the digital image file) may be extracted from whole text along with its coordinates.
207 This may represent a queue mechanism which may pick up or receive row-wise data items with location information extracted from the digital image file for processing. Some embodiments may process rows or data items including rows of text sequentially, or “one-by-one”, and provide or input one row of text after another to the machine learning model, GenAI, or LLM component.
208 This may represent a logical block and/or module which may take or receive a row-wise data item and location word information from previous queue component as input. Here, generative AI may be used to recognize or identify or detect PII in the input text, to find its coordinates information in the input data, and to return or output meaningful or desirable information, for example in the following format:
   “Line”: “XXXXX”, “Type”: “Full Name”, “Bounding Box”: [{‘x’:1559, ‘y’:23}, {‘x’:1402, ‘y’:22}, {‘x’:1559, ‘y’:45}, {‘x’:1402, ‘y’:44}]
      which may be, e.g., a JSON array.
209 This may represent a storage mechanism where, e.g., PII information in JSON format may be stored.
210 This may represent a queue mechanism which may include a list of PII words or information, along with location information or coordinates, which may be masked, shielded or concealed.
211 This may represent a logical block and/or module for image masking. Here, the original image or input image data may be masked, e.g., in the location corresponding to PII data. Thus, parts of the image including sensitive data or information may be replaced with a color mask.
212 A masked image or image file may be stored in the system for further analytical operations and consumptions.

### Table 2

Additional or alternative components and/or operations and/or data formats may be used in different embodiments of the invention.

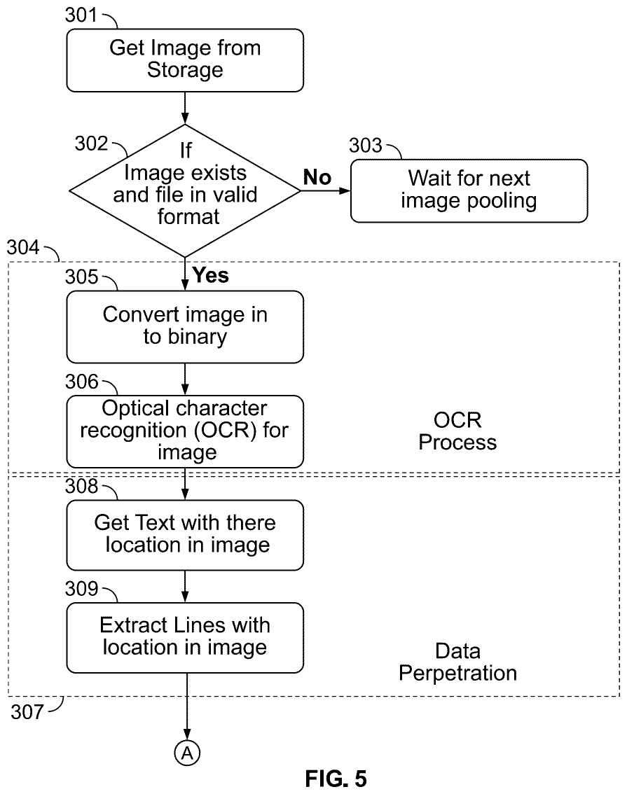

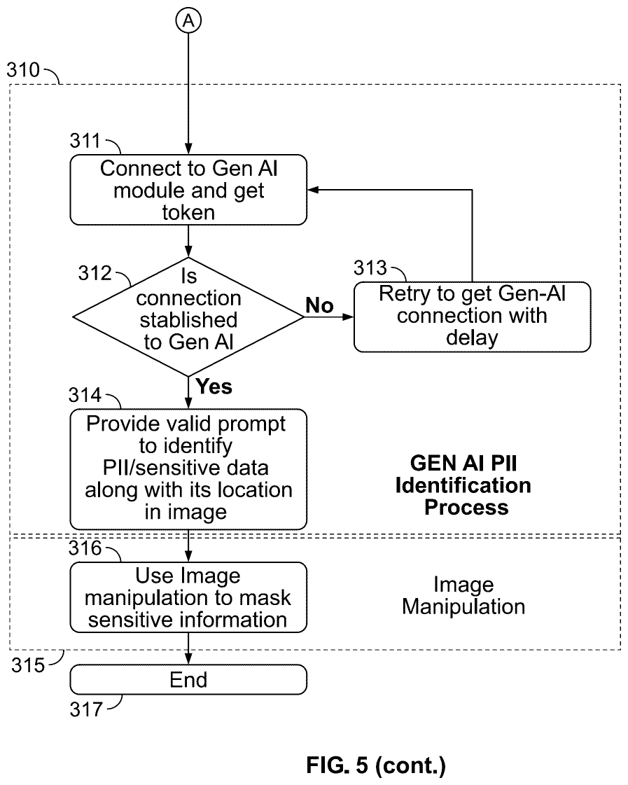

FIG. 5 shows an example information flow between different components according to some embodiments of the invention.

Example elements and/or operations of FIG. 5 are described in Table 3:
301 This may be or may represent a queuing system or mechanism to get or fetch images, image files, or image data from a database or external system.
302 This may be a system, component or module where the images may be checked, e.g., if they are present (e.g., if images were fetched in element 301) and/or if images are in a correct/incorrect format or not. For example, in some embodiments of the invention, a digital image or image data may be required to be provided in a specific format or formats such as, e.g., the JPEG, PNG, GIF, or BMP format, and the size of the image or data may be required to between 50×50 and 4200×4200 pixels and/or not to exceed a file size of 10 megabytes. Additional or alternative constraints relating to allowed and/or forbidden formats or size may be used in different embodiments.
303 This may be a queuing system or mechanism where raw, pre-masked images may be fetched for processing.
304 This may be an optical character recognition (OCR) processing stage of module for image analysis.
305 This may include converting an image to a binary format (e.g., an uncompressed binary file including raw pixel values without any compression or encoding, which may for example be achieved using an appropriate Python library or libraries, such as for example the Azure OCR library and/or the whisper-timestamped library—which may include or may use deep learning based object detection tools and techniques adapted or trained specifically for character or token recognition).
306 This may be or may represent a logical block, component or module which may convert an image into text data items using OCR. This operation may output or return the text recognized or identified in the image along with its location or coordinates in the image.
307 This may be a data preparation stage.
308 This may include getting or extracting text in the image received, e.g., from the above operations along with its location on image.
309 This may include extracting row-wise data items from the text including location information, such as, e.g., coordinates in the image or image file.
310 This may be a GenAI PII identification process or operation
311 This may be or may represent a connection mechanism to connect to a machine learning component such as, e.g., a GenAI system, component or module to get or receive a required key or token after authentication.
312 This may include a test or checking whether connection to the machine learning module or system is successful, e.g., by validating the received key or token.
313 This may be a retry mechanism, or a repeating connection attempt, e.g., in case of an unsuccessful connection attempt (e.g., in case an invalid key or token was used in 312).
314 This may be or may represent a logical block and/or module which may take or may receive row wise text data items including location information (as, e.g., extracted from an image file) as input. Here, a GenAI component may be used, e.g., to identify or detect PII in a given text, to find its location information in the input data, and to return or output meaningful information in a requested format, such as, e.g.:
   “Line”: “XXXXX”, “Type”: “Full Name”, “Bounding Box”: [{‘x’:1559, ‘y’:23}, {‘x’:1402, ‘y’:22}, {‘x’:1559, ‘y’:45}, {‘x’:1402, ‘y’:44}]
   The output may be, for example, in a JSON array format.
315 This may be an image manipulation stage or process
316 This may be or may represent a logical block and/or module which may be responsible for image masking. Here, the original image may be masked in the location received along with the text identified as PII data. Parts of the image which may include sensitive data, may be replaced, e.g., with a blank color mask.

### Table 3

Additional or alternative components and/or operations and/or data formats may be used in different embodiments of the invention.

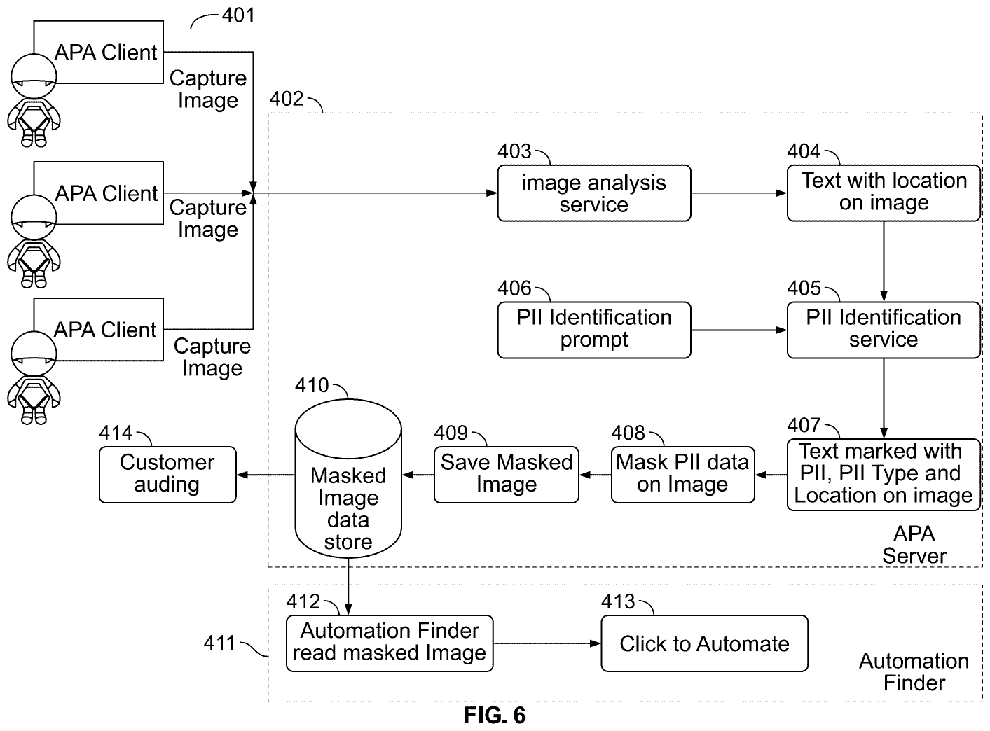

FIG. 6 shows an example system for intelligent masking integrated with external systems and components according to some embodiments of the invention.

Example elements and/or operations of FIG. 6 are described in Table 4:
401 This may represent a native client or data collection software program which may be executing on, e.g., an agent's or user's desktop computer or terminal and which may for example capture images, perform screen recording operations, and the like. For example, in some embodiments, a program or client may be, e.g., a desktop application such as for example the CXone Agent (CXA) application by NICE Ltd., which may be executed on an user's or agent's system or machine. A data collection application or program may monitor or collect desktop event information such as for example application/program/process start times and/or end times (e.g., as timestamps) along with corresponding application/program/process identifiers. In some embodiments, a data collection software process or client and/or a server computer may detect that a screenshot was taken or captured, for example based on process identifiers associated with screenshot capture processes as collected by the software or client. In some embodiments, captured screenshots may automatically be sent or transmitted to a server computer such as, e.g., a workforce management system (WFM) system. The server or system may use the captured screenshots, or the detection of snapshots or screenshots taken by the user, e.g., as part of identifying or executing automation workflows (for example using process mining techniques and procedures). In some embodiments, the collection software or client may capture screenshots, e.g., using the Windows built-in copyFromScreen( ) function or method available in a dedicated graphics class or library. Additional or alternative example data collection tools or components may be used in different embodiments.
402 All points addressable (APA) Server handling the masking, shielding or concealing logic.
403 This may represent a logical block and/or module which may convert image into text using OCR.
404 This may return the text on image along with its location or coordinates within the digital image file.
405 This may represent a logical block and/or module which may receive row wise text from an image file along with their location as input, may feed the input data to an GenAI or LLM component or module. Generative AI may be used to identify or detect PII in a given text, to find the text's location information in the given input data and, and to output or return meaningful information, e.g., in a desired format.
406 This may represent a custom or dedicated PII identification prompt provided to the LLM.
407 This may fetch text from the image along with its coordinates (e.g., the text identified or recognized as PII by the LLM).
408 This may represent a logical block and/or module which may perform image masking. Here, the original image or image file may be masked in locations received along with, and corresponding to, PII data. Then sub parts of the image including sensitive data of information may be replaced, e.g., with a color mask.
409 This may store or save a masked image file or data structure in memory or storage.
410 This may represent a masked image datastore where masked images may be stored.
411 This may represent an example integration with the Automation Finder (AF) system and framework by NICE LTD. Additional or alternative external systems and components may be integrated with different embodiments of the invention.
412 AF may read data from masked image datastore 410 and may use read data, e.g., for further analytics and insights.
413 AF features such as, e.g., “click to automate” may be provided, e.g., based on captured image and/or masked outputs.
414 Masked images may be saved or stored, e.g., on the user's side, such as for example in a storage system or a customer or user device, e.g., for auditing purposes.

### Table 4

Additional or alternative components and/or operations and/or data formats may be used in different embodiments of the invention.

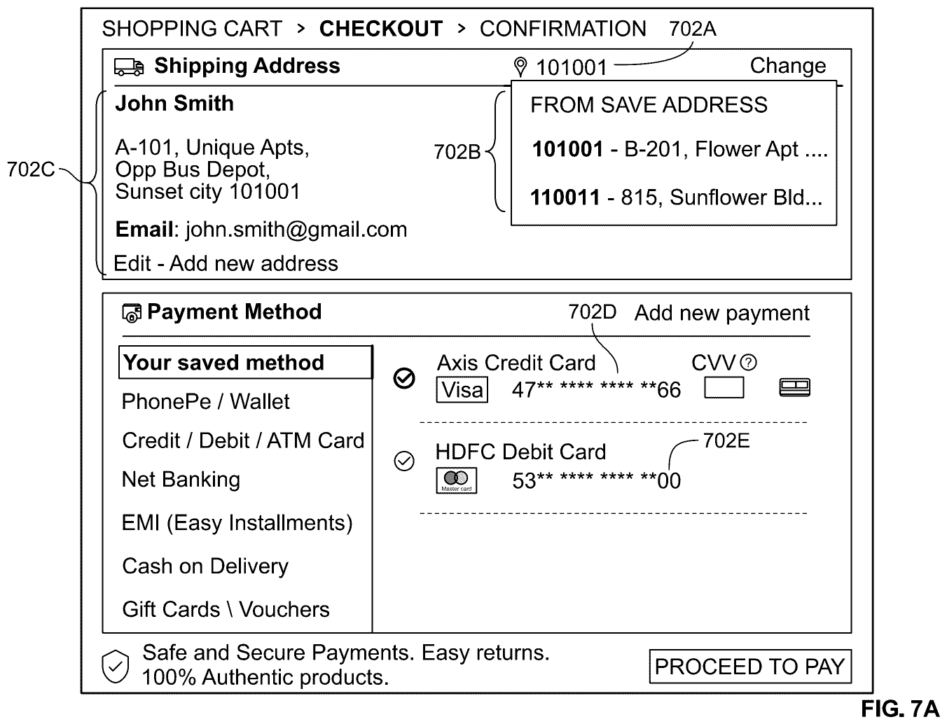

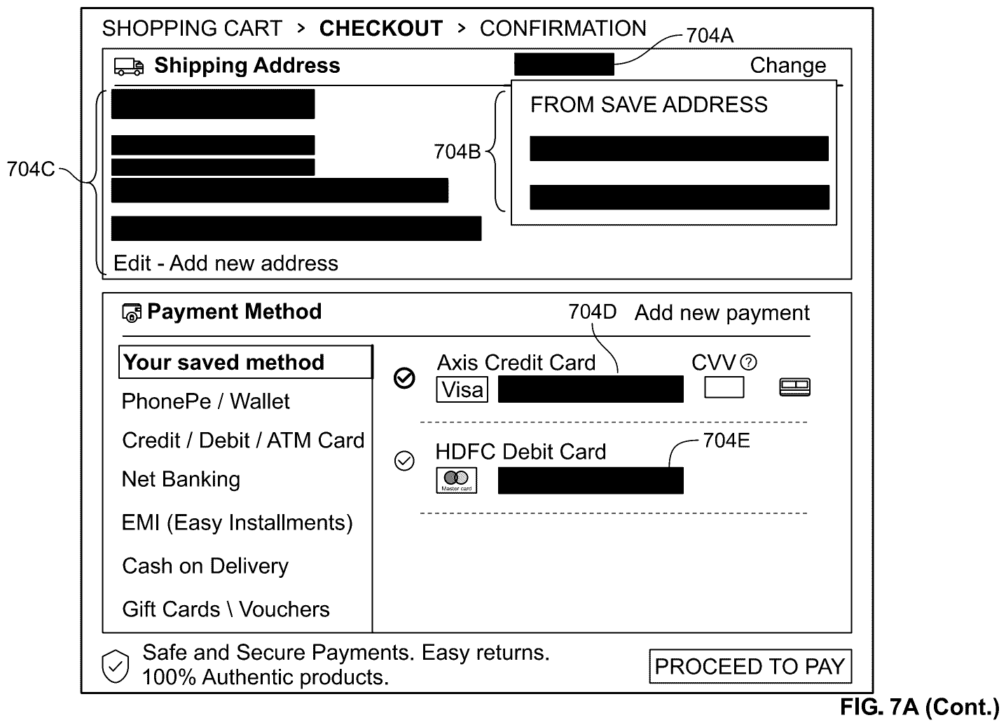

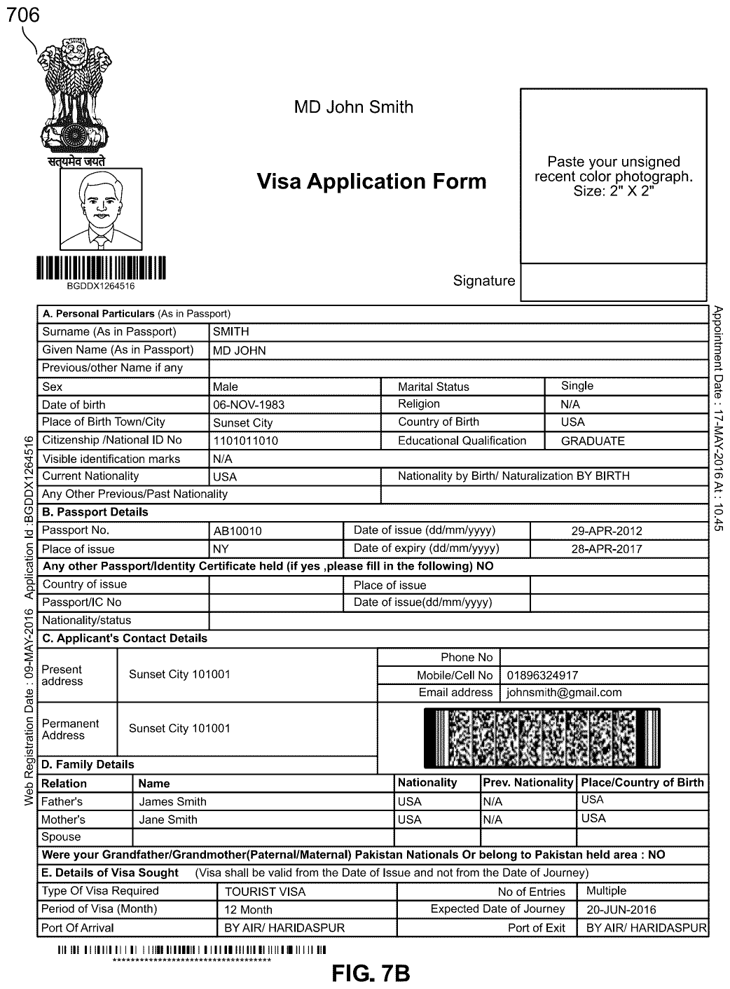

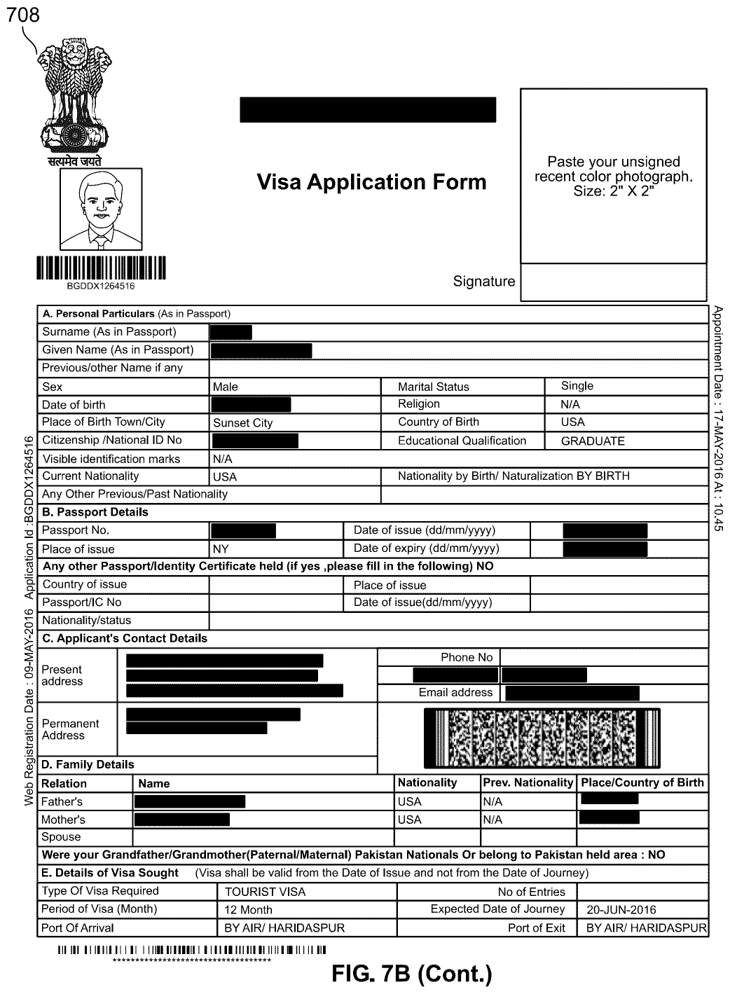

FIG. 7A-B shows example results of image masking according to some embodiments of the invention.

Elements 702A-E are shown to include personal information and credit card information as PII data provided on an example checkout form, e.g., on an e-commerce website. This form, containing the PII data, may be considered as an input image file or the original digital image that may be processed by some embodiments of the invention. Elements 704A-E show an example output image of a masking or data shielding or concealing process according to some embodiments of the invention. In Elements 704A-E, it can be seen that a blank color mask or filling may be placed at the locations or coordinates of elements 702A-E, to hide the PII data included in the original, input image, after producing a new, altered image. In a similar manner, an input such as, e.g., visa application form 706 may be masked by some embodiments of the invention to produce a masked output file or image 708, where PII data and relevant fields in input form 706 may be covered with or hidden behind color masks or fillings. Additional or alternative masking outputs and/or example use case input images (relating, e.g., to various topics, subjects of domains, such as, e.g., financial data, personal security, and more) may be used in different embodiments.

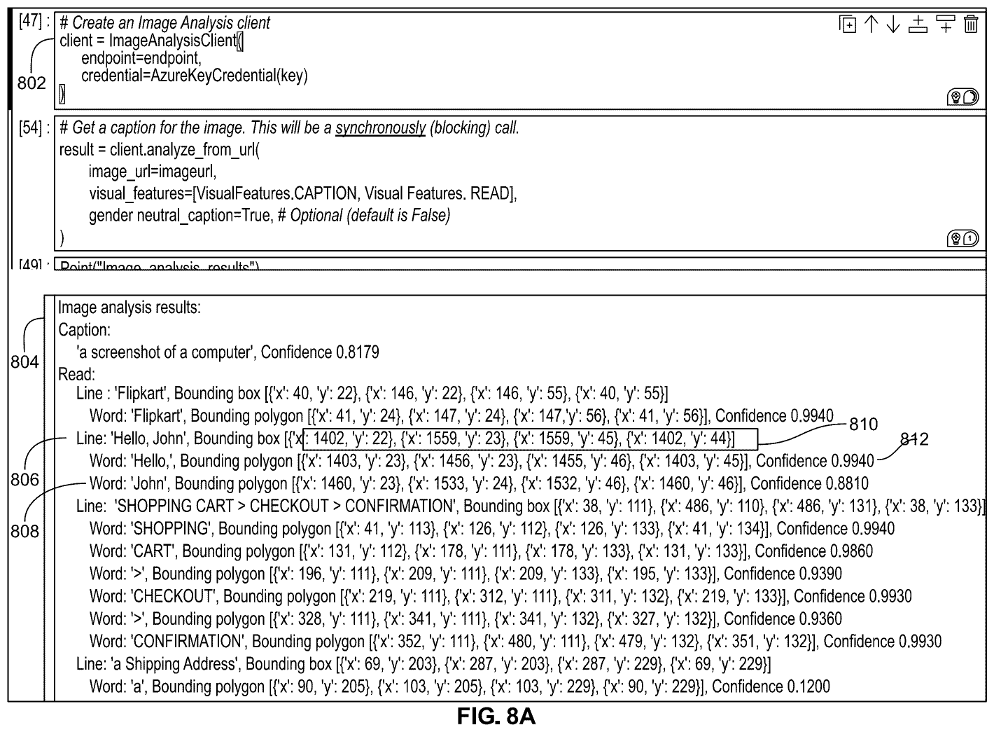

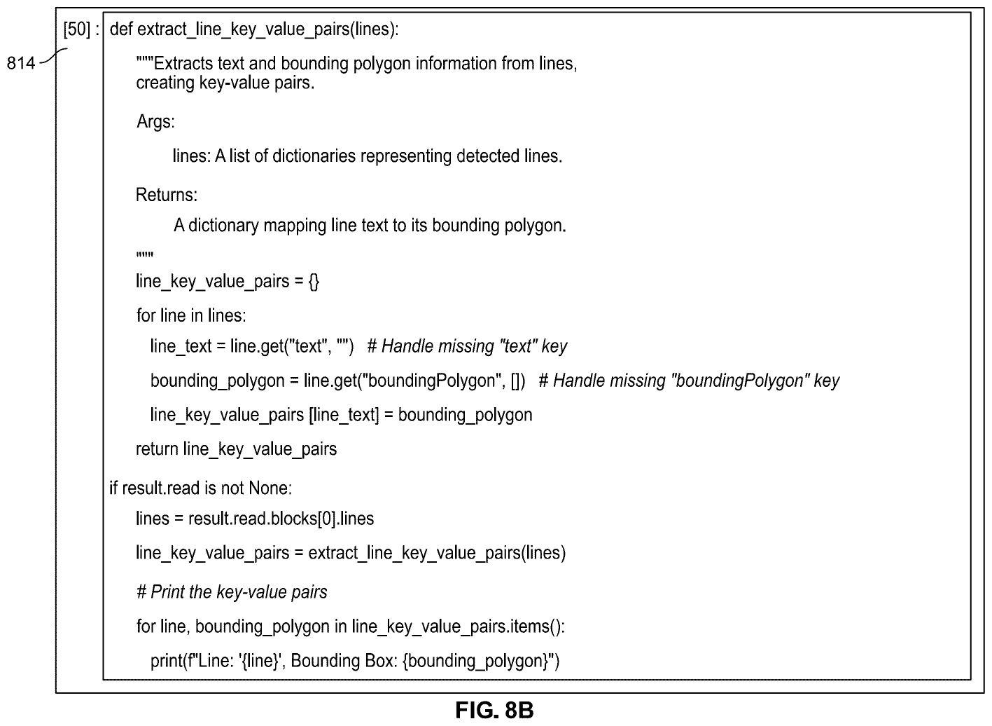

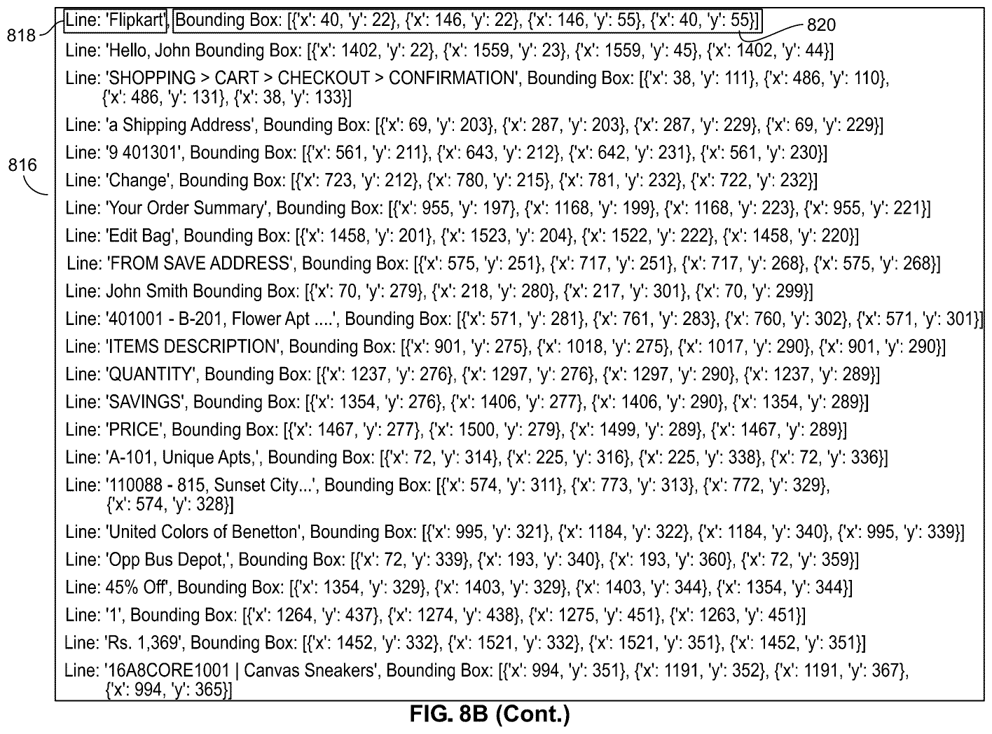

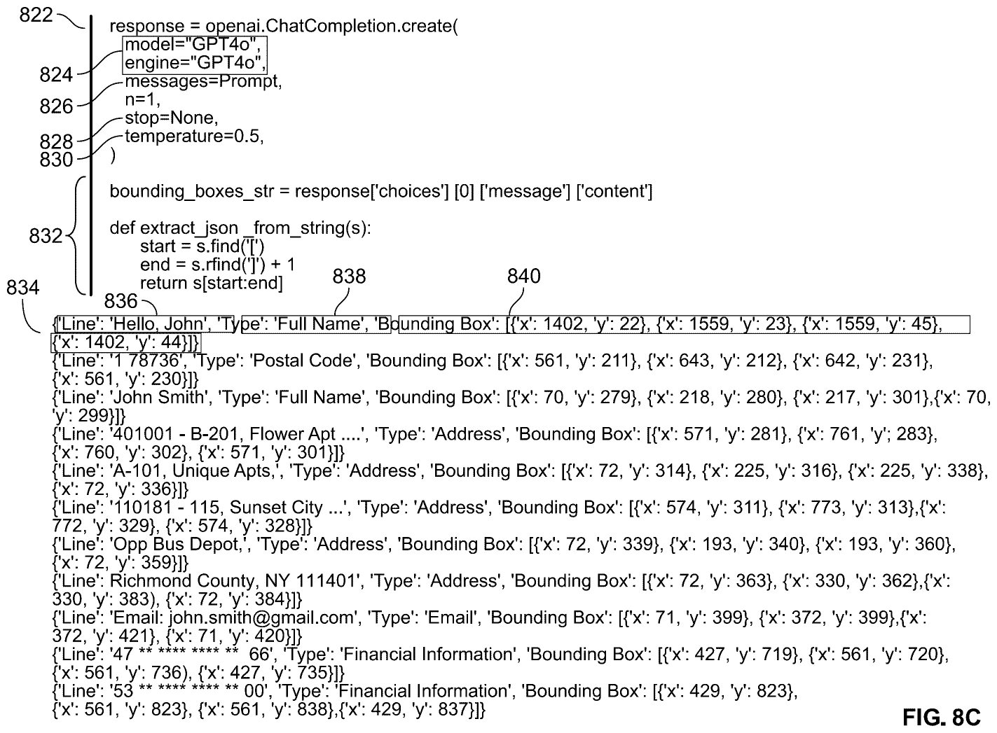

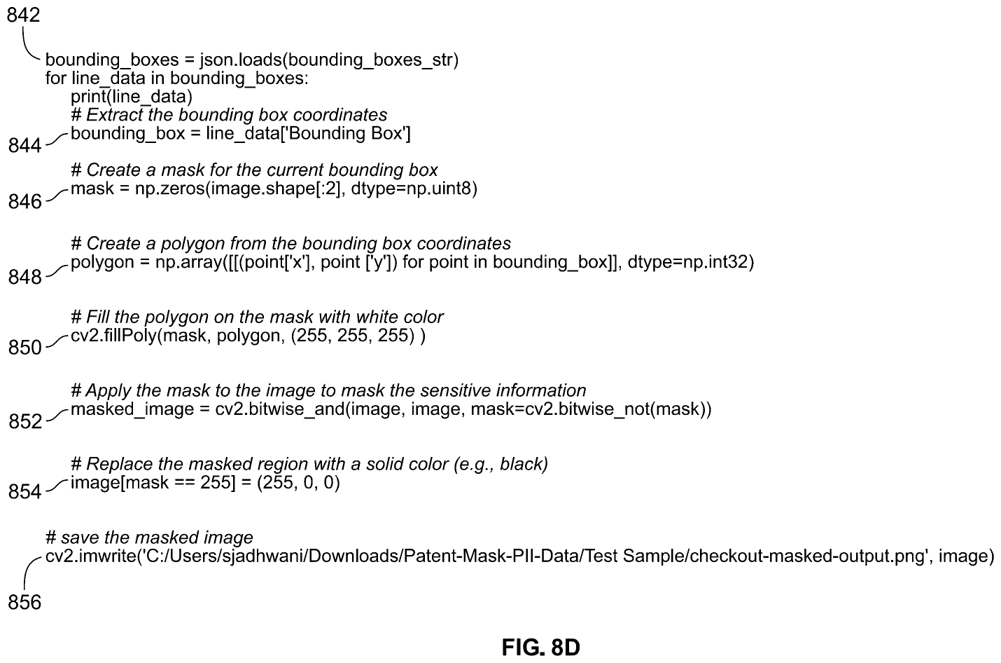

FIG. 8A-D shows example code snippets and example outputs that may be used and/or produced in some embodiments of the invention.

According to some embodiments of the invention, text detection and/or extraction from an image may involve analyzing visual content to identify and interpret written characters. This may include, for example, segmenting the image into regions and/or calculating bounding boxes or polygons including text or text portions or segments. Some embodiments may use machine learning model and/or artificial intelligence based OCR techniques—such as for example the You Only Look Once (YOLO), the Single Shot Multibox Detector (SSD), and the TextBoxes and EAST (Efficient and Accurate Scene Text) techniques—to determine the spatial extent of each detected text element. Bounding boxes or polygons may be computed or provided using these example techniques, e.g., as shapes or rectangular areas that may enclose the detected text and that may be defined by, e.g., using various parameters or dimensions such as for example their corner coordinates—which may enable accurate extraction and representation of the text in its original position within the image. Additional or alternative OCR techniques may be used in different embodiments.

In some embodiments, the extracted data items comprise location information, the location information describing locations of one or more of the strings in the image file. Some embodiments may include extracting one or more of the data items from the image file, wherein the extracting comprises converting the image file into a binary format.

Element 802 shows an example Python code implementation of a process or function that may take or receive an image uniform resource locator (URL) as input. In some embodiments, optical character recognition (OCR) tools such as for example the Azure OCR library for detecting or extracting text (such as, e.g., text portions/tokens/strings) from image data along corresponding location information describing, for example, a bounding box or boxes covering or surrounding specific text portions, tokens or strings in the image—such as for example lines or rows of text within the digital image. According to some embodiments, the coordinates of a bounding box or polygon associated with a given string (or line, or token) may describe or may be referred to as the location of the string in the digital image file. In some embodiments, example code snippet 802 may represent or may correspond to flow or operation 304 where a dedicated library (such as for example the whisper-timestamped library) may be used to perform the required processing operations or steps—and which includes operation 305 (converting the image file or data into a binary format, or an uncompressed binary file including raw pixel values without any compression or encoding, using, e.g., the example libraries mentioned herein) and operation 306 (OCR logic to extract text or strings/tokens from image data for example along with location or coordinate information describing, e.g., a bounding box or polygon surrounding the extracted text). An example output of this flow and example code may be, e.g., element 804—which may include for example line information 806 and string/word/token information 808 for each line/string/word/token, respectively, in the text extracted from an input image. Information describing lines or word/tokens extracted from an input image may include, for example, bounding box or bounding polygon coordinates or location 810, which may designate or specify coordinates/dimensions of a box/polygon surrounding or covering the specific text portion, line, word or token considered (and, e.g., covering only that specific line/word/text portion/token and not other lines/words/tokens and/or additional objects or elements). Information describing extracted lines/words/text portions/tokens may include a confidence level 812 which may describe the statistical significance in the recognition of the extracted text and/or calculation of its surrounding box/polygon. In some embodiments, a confidence level above a predetermined threshold T (where T may be, e.g., 0.7 or 70%) may be required as a condition for using identified or extracted text data or items and/or for providing lines of text to the machine learning model or LLM. For example, if a given text or string extracted from an image using the Azure OCR library is ascribed or assigned a confidence level of 0.6 or 60%, some embodiments may discard or filter out the text or string and/or initiate or repeat a character or token detection step to improve the confidence level. Accordingly, the text and/or string having a confidence level below T=0.7 or 70% may not be provided or input to a machine learning model or LLM for identifying PII data, and no PII data may be detected in that specific text or string. Additional or alternative information or fields may be extracted from image data and provided by different embodiments of the invention.

Element 814 shows an example Python code implementation of a data preparation process, which may receive extracted text and location data (such as for example provided in operation 314), and which may return or output a dictionary data structure mapping lines of text to their corresponding bounding boxes or polygons. In some embodiments, example code snippet 814 may represent or may correspond to flow or operation 307, and a dedicated library (such as for example the whisper-timestamped library) may be used for performing corresponding operation 308 (where text may be provided and may be mapped, linked, or associated with its coordinates as provided, e.g., using an OCR module, process or service) and operation 309 (where row-wise information or where each row or line in the text may be linked or associated with location information, dimensions, or coordinates—for example in a key-value format and/or using a JSON file). An example output of this flow and example code may be, e.g., data item or element 816 including key-value pairs of a given line's text or content 818 and bounding box dimensions or coordinates 820 surrounding that line's text or content. Additional or alternative data preparation, processing, or preprocessing steps may be included in different embodiments.

Some embodiments of the invention may include identifying, using a machine learning model, one or more tokens in an image file, the identifying using one or more data items extracted from the image file, wherein the extracted data items comprise one or more strings. In some embodiments, one or more of the identified tokens comprises personally identifiable information (PII). In some embodiments, each of one or more data items comprises one line of text extracted from the image file, and identifying of one or more of the tokens comprises sequentially inputting each of the items to the machine learning model.

Element 822 shows an example Python code implementation of a machine learning model based identification of PII in image data, which may receive data items including, e.g., text or text portions (where text may be provided, e.g., as a plurality of tokens or strings and/or as the contents of a JSON file) and location data (which may be provided, e.g., as coordinates or dimensions of boxes or polygons covering or surrounding a plurality of tokens or text portions) extracted from an digital image file as input. In some embodiments, data items input to a machine learning model, LLM, or GenAI component may be or may include, e.g., as a dictionary data structure in JSON format—which may be included in, or may be sent or transmitted to a machine learning model or module (such as for example an LLM or GenAI component or service) with an appropriate LLM or GenAI prompt for PII identification. In some embodiments, example code snippet 822 may represent or may correspond to flow or operation 310, where a connection (such as for example a big data connection) to a machine learning model component, module or service may be established and validated (operations 311 and 312) and/or may be retried or reestablished if needed (e.g., if a validation method such as for example a key or validation token matching or validation method is unsuccessful; operation 313), and where a logical block and/or model and/or operation take or receive data items of row-wise text extracted from an image file along with corresponding location or coordinate information as input. As part of this flow, a machine learning model or component such as, e.g., an LLM or GenAI module or service may be used to identify or detect PII or text portions or tokens associated with PII data—in the text or contents of each line of text, and to find or return PII items or elements (e.g., as a plurality of tokens or strings) as well as determine their location or coordinate information corresponding to each PII item, string, token, or element within the image file—for example by returning the location of a bounding box or polygon surrounding the PII item or element as determined or received from an OCR process. An example row-wise input data item or an input item describing a row or line of text extracted from an image file may include text and location or coordinate information, which may also be referred to as “timestamped information”, for a given row or line of text extracted from the image file or input. In some embodiments, row-wise or line-wise data items may be inputted or provided to the machine learning model, LLM, or GenAI component in a serial or sequential manner—such that, e.g., PII data may be identified or detected separately for each line of text. Some embodiments may accordingly enable identifying PII or sensitive data in a context-dependent or context-sensitive manner, where for example, for a given row or line of text L=“Password: <XYZ>”, a PII element or time “XYZ” may identified or detected as PII data by a machine learning or LLM detecting or determining that it is preceded by the string “Password” (without the string or word “Password” included in the same line and considered as the “context” or “XYZ”, some embodiments may not determine, label or detect that “XYZ” corresponds to PII or sensitive data). Context sensitive PII detection according to some embodiments of the invention may be achieved using a machine learning model or LLM analyzing surrounding words and patterns within a sentence/text using statistical relationships learned during training, which may enable it to infer meaning and to detect PII or sensitive data based on, for example, how words, terms, or tokens are commonly used together or how close they may be to one another in a sentence or string. Serially or sequentially providing row- or line-wise data items may be performed, e.g., using appropriate queueing systems and techniques (see nonlimiting examples herein). Additional or alternative formats and/or contents may be used in different embodiments.

According to some embodiments, example code snippet 822 may require or include specifications of various parameters and/or values, such as for example the LLM or GenAI model and/or engine to be used 824, a message, request, data item, or command 826 to be sent or transmitted to the model/engine/component (which may be for example an appropriate LLM prompt for PII identification or detection), stop commands or conditions 828 (which may for example include emergency conditions based on which the process may be terminated or come to a halt without generating a corresponding output), a temperature parameter 830 specifying a temperature value to be used by the machine learning or GenAI model/engine/component, and additional commands or variables 832 relating, e.g., to formatting of outputs by the machine learning model or component and to the form of the input provided to it (such as for example providing each line of text separately from other lines of text to the model or component).

A nonlimiting example LLM prompt for PII for PII identification or detection which may be used in some embodiments of the invention is provided in Table 5:

```
TABLE 5
Prompt = [
  {″role″: ″system″, ″content″: ′′′′′′
  Extract/identify/detect all personally identifiable information (PII) and all text
  portions or tokens including or associated with PII from the given/attached data
  item/text/string, including full name, address components (including any parts
  spread across multiple lines), email, phone number, and financial details. For
  each piece of PII, include the exact line of text it appears in the input, without any
  modifications or merging and the type of PII it is. Provide the output in JSON
  format, with each PII item as a separate object, including the line of text and
  determine the type of PII included in the tokens. Also, include/determine the
  corresponding bounding boxes surrounding/including each PII item in the image
  file. Please consider date of birth, City names as part of PII. Output should be
  valid JSON format.
  ]
```

According to some embodiments a “type” may be assigned by a machine learning model, LLM, or GenAI model to detected items—which may be, e.g., a classification or category label that describes the nature or characteristics of the detected item. In some embodiments the model may assign this type based on patterns, features, or predefined criteria learned from training data, helping to organize, process, and understand the data by grouping similar items together, e.g., according to their attributes or intended use. A nonlimiting example output JavaScript object notation (JSON) file that may be produced by some embodiments of the invention (e.g., based on an example prompt according to Table 5) is provided in Table 6.

```
TABLE 6
Output:
[
  {
    ″Line″: ″[Line of text containing PII]″,
    ″Type″: ″[Type of PII]″,
    ″Bounding Box″: [
      {
        ″x″: [X-coordinate of top-left corner of bounding box],
        ″y″: [Y-coordinate of top-left corner of bounding box]
      },
      {
        ″x″: [X-coordinate of top-right corner of bounding box],
        ″y″: [Y-coordinate of top-right corner of bounding box]
      },
      {
        ″x″: [X-coordinate of bottom-right corner of bounding box],
        ″y″: [Y-coordinate of bottom-right corner of bounding box]
      },
      {
        ″x″: [X-coordinate of bottom-left corner of bounding box],
        ″y″: [Y-coordinate of bottom-left corner of bounding box]
      }
    ]
  },
  ...
]\n′′′′′′},
      {″role″: ″user″, ″content″: f″{line_key_value_pairs.items( )}″},
  ]
```

Where each “line” may be or may include the plurality of text portions, tokens or strings associated or including PII data, where the “type” may describe the specific PII data or sensitive information identified in the relevant line and/or included in specific tokens (as may be determined by a machine learning, LLM or GenAI component, e.g. based on an appropriate LLM or GenAI prompt or command such as, e.g., illustrated herein), and where “x” and “y” values describe dimensions of the determined location, bounding box or polygon surrounding or covering the PII tokens/strings within the image file. An LLM or GenAI prompt according to some embodiments may be used or may require or specify a plurality of PII detection iterations, for example in order to increase the accuracy or statistical robustness of PII identification or detection, and to avoid detection of only partial PII data such as, e.g., partial addresses or multi-line PII data, and the like. In one example, a first PII detection iteration may include inputting or feeding all lines or rows of text detected in a digital image into a machine learning model, LLM, or GenAI component in a serial manner (e.g., row 1 followed by row 2, then by row 3, . . . etc.) and detecting or identify PII in some of the rows when each row is considered in isolation. A second PII detection iteration (which may follow the first PII detection iteration) may include inputting or feeding all lines at once, or all together, into the machine learning model, LLM, or GenAI component for example using the same PII detection prompt used in the first iteration. Some embodiments may compare detected PII elements from the first iteration (e.g., “John Doe”, “279279”, “Haight St. ”) with detected PII elements from the second iteration (e.g., “John Doe”, “Haight St. ”, “Floor 20”) and may for example add the PII elements from the second iteration to the detected PII elements from the first iteration (such that the plurality of PII elements detected in the two iterations may include the PII elements “John Doe”, “279279”, “Haight St. ”, “Floor 20”. These elements may be output by the machine learning model, LLM, or GenAI component as the plurality of PII elements, items, or tokens detected). Additional or alternative PII detection workflows and/or operations may be included and used in different embodiments.

Another nonlimiting example output of this flow and example code may be, e.g., element 834 which may be for example JSON file including a list or set of PII or sensitive information elements or items, where each item may include, e.g., the contents or text of a relevant line of text data item extracted from the digital image file in which PII or sensitive information was detected 836, a type of sensitive information or PII for the information or data item 838 (which may for example be determined by a machine learning component such as, e.g., an GenAI or LLM module or service using an appropriate prompt or command), and bounding box coordinates, dimensions, or location surrounding the relevant line 840. In example output item 834, detected PII data may be provided in the following format:
“Line”: “XXXXX”,
   “Type”: “Full Name”,
   “Bounding Box”: [{‘x’:1559, ‘y’:23}, {‘x’: 1402, ‘y’:22}, {‘x’:1559, ‘y’:45}, {‘x’:1402, ‘y’:44}]
      Although additional or alternative formats and/or fields or items may be used or included in different embodiments.

Example machine learning models such as for example GenAI or LLM components or modules that may be used in some embodiments may include, e.g., Generative Pre-trained Transformer (GPT) or Bidirectional Encoder Representations from Transformers (BERT) models or services, which may be, e.g., constructed using a transformer architecture and trained in two phases: pre-training on large, comprehensive text corpora to predict the next word in a sentence, and fine-tuning on specific tasks (such as, e.g., identifying PII in input texts) to improve performance in those areas (which may be performed, for example using reinforcement learning techniques and a labeled dataset including, for example, a plurality of input texts and corresponding portions or subtexts of the text which may be labeled to include PII data, e.g., by a subject matter expert or system administrator). Additional or alternative models, architectures, or LLM services (which may be incorporated into some embodiments, e.g., using appropriate APIs) may be used in different embodiments.

Some embodiments of the invention may include masking one or more of the identified tokens in the image file. In some embodiments, the masking comprises coloring one or more of the locations in the image file and/or coloring the box within the image file. In some embodiments, the masking comprises generating a masked image file, the masked image file not displaying the masked tokens.

Element 842 shows an example Python code implementation of a PII masking, shielding or concealing process according to some embodiments of the invention, which may receive identified or detected PII data (such as, e.g., a plurality of tokens or strings, which may for example be included in a JSON file) and its location data as input—as provided, e.g., by a machine learning, LLM, or GenAI model or component. The process may create, generate, return or output a masked or altered image file or data item as output. In some embodiments, example code snippet 842 may represent or may correspond to image manipulation flow or operation 315, and corresponding operation 316 (where an appropriate module or logical block may be responsible for performing image masking, for example to mask the original image in specific locations, portions, or parts including PII data. Portions or parts including sensitive data or information may be colored or replaced with a color mask or with a blank color filled box or polygon). For each line including tokens or strings identified as PII or sensitive information, some embodiments may, for example: extract the locations, bounding box or polygon information associated with the line 844 (as provided, e.g., in an output provided by a machine learning model or component), define or create a mask to cover, shield or conceal the relevant tokens or strings 846, define or create a polygon or box object based on or using the extracted location information 848, apply the mask to the polygon or fill/color the polygon with color as defined in the mask object 850, generate, create or write to a masked image object or file where the mask or coloring is applied to the relevant locations in original image 852, and replace the masked region in the masked image file with solid or blank color 854 (such that the newly generated or created masked image file is not displaying or not showing the masked, shielded, or concealed locations/tokens—or such that the sensitive information of PII is absent from the masked or newly created image). After masking, shielding, concealing, or coloring all relevant regions, locations, parts or portions in the image, some embodiments may save the final, masked image and store it in the system's memory 856. Additional or alternative masking methods and/or operations may be used in different embodiments.

An example output of this flow and example code may be, e.g., masked images or outputs such as for example shown in elements 704A-E and 708.

Some embodiments may include transmitting the masked image file to a remote computer system, the transmitting over a communication network.

In some embodiments, a masked image file may be sent or transmitted to a remote computer system (which may be, e.g., a computer system physically-separate from the system performing image masking and/or additional operations or procedures described herein) for example by securely sending an image in which PII was masked, shielded, or concealed while ensuring privacy and compliance with data protection regulations. For example, once an image is masked, some embodiments may send or transmit the image over a data or communication network (such as for example described with reference to FIG. 2 and/or in a case where the remote computer system may be part of an external system or platform as, e.g., described with reference to FIG. 6). In some embodiments, transmission may involve encrypting the masked image to prevent unauthorized access during transit—using encryption protocols and techniques such as for example the transport layer security (TLS) protocol, the secure file transfer protocol (SFTP), the advanced encryption standard (AES) algorithm, and the like. The remote computer system, upon receiving the masked image file, may then store, process, or analyze the image as needed. Additional or alternative sending or transmission protocols may be used in different embodiments.

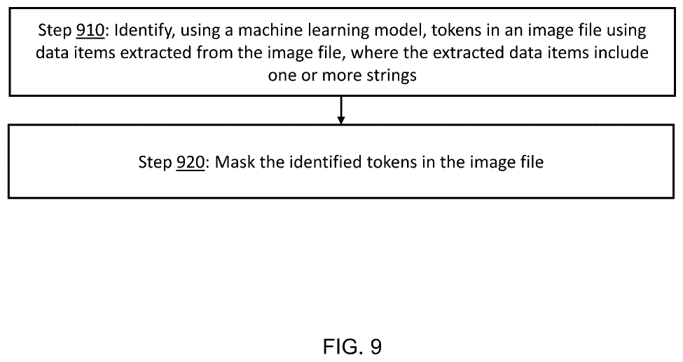

FIG. 9 is a flowchart of an example method for automatically identifying and masking information according to some embodiments of the invention. In operation 910, some embodiments may identify, using a machine learning model, one or more tokens in a digital image or image file (where the machine learning model may be, e.g., a LLM or GenAI component, module or service; where the identifying may be performed using an appropriate LLM or GenAI prompt; and where the tokens may be, e.g., tokens/strings including PII data). The identifying of the tokens in the image file may be performed using one or more data items extracted from the image file, where the extracted data items may include one or more strings (for example, the extracted data items may be row- or line-wise items where each item may include one string such as, e.g., a row of text from the image file). Some embodiments may mask or color one or more of the identified tokens (or the PII data) in the image file—which may be performed for example by applying a colored mask to locations of identified tokens or relevant lines/strings, or by coloring boxes or polygons bounding, covering or surrounding the identified tokens (operations 920). Additional or alternative operations may be performed, e.g., as part of token identification and/or masking by different embodiments of the invention.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for automatically identifying and masking information using a machine learning model, the method comprising, using one or more computer processors:
identifying, using a machine learning model, one or more tokens in an image file, the identifying using one or more data items extracted from the image file, wherein the extracted data items comprise one or more strings; and
masking one or more of the identified tokens in the image file.

2. The method of claim 1, wherein the extracted data items comprise location information, the location information describing locations of one or more of the strings in the image file; and
wherein the masking comprises coloring one or more of the locations in the image file.

3. The method of claim 1, comprising extracting one or more of the data items from the image file, wherein the extracting comprises converting the image file into a binary format.

4. The method of claim 1, comprising determining coordinates of a box within the image file, the box including one or more of the identified tokens; and
wherein the masking of one or more of the identified tokens comprises coloring the box within the image file.

5. The method of claim 1, wherein one or more of the identified tokens comprises personally identifiable information (PII), and wherein the identifying of one or more of the tokens comprises determining a type of PII included in the tokens.

6. The method of claim 1, wherein the masking comprises generating a masked image file, the masked image file not displaying the masked tokens, and wherein the method comprises transmitting the masked image file to a remote computer system, the transmitting over a communication network.

7. The method of claim 1, wherein each of one or more data items comprises one row of text extracted from the image file, and wherein the identifying of one or more of the tokens comprises sequentially inputting each of the items to the machine learning model.

8. A computerized system for automatically identifying and masking information using a machine learning model, the system comprising:
a memory; and
one or more processors configured to:
identify, using a machine learning model, one or more tokens in an image file, the identifying using one or more data items extracted from the image file, wherein the extracted data items comprise one or more strings; and
mask one or more of the identified tokens in the image file.

9. The system of claim 8, wherein the extracted data items comprise location information, the location information describing locations of one or more of the strings in the image file; and
wherein the masking comprises coloring one or more of the locations in the image file.

10. The system of claim 8, wherein one or more of the processors is to extract one or more of the data items from the image file, wherein the extracting comprises converting the image file into a binary format.

11. The system of claim 8, wherein one or more of the processors is to determine coordinates of a box within the image file, the box including one or more of the identified tokens; and
wherein the masking of one or more of the identified tokens comprises coloring the box within the image file.

12. The system of claim 8, wherein one or more of the identified tokens comprises personally identifiable information (PII), and wherein the identifying of one or more of the tokens comprises determining a type of PII included in the tokens.

13. The system of claim 8, wherein the masking comprises generating a masked image file, the masked image file not displaying the masked tokens, and wherein one or more of the processors is to transmit the masked image file to a remote computer system, the transmitting over a communication network.

14. The system of claim 8, wherein each of one or more data items comprises one row of text extracted from the image file, and wherein the identifying of one or more of the tokens comprises sequentially inputting each of the items to the machine learning model.

15. A method for automatically detecting and shielding information using a large language model (LLM), the method comprising, using one or more computer processors:
detecting, using a large language model (LLM), one or more text portions in a digital image, the detecting using one or more data items extracted from the digital image, wherein the extracted data items comprise one or more strings; and
shielding one or more of the detected text portions in the image file.

16. The method of claim 1, comprising extracting one or more of the data items from the digital image, wherein the extracting comprises converting the digital image into a binary format.

17. The method of claim 1, comprising determining dimensions of a polygon within the digital image, the polygon including one or more of the detected text portions; and
wherein the shielding of one or more of the detected text portions comprises coloring the polygon within the image file.

18. The method of claim 1, wherein one or more of the detected text portions comprises sensitive information, and wherein the detecting of one or more of the text portions comprises outputting, by the LLM, a type of sensitive information included in the text portions.

19. The method of claim 1, wherein the shielding comprises creating a masked image file, the masked image file not showing the shielded text portions, and wherein the method comprises sending the masked image file to a remote computer, the sending over a data network.

20. The method of claim 1, wherein each of one or more data items comprises one line of text extracted from the image file, and wherein the detecting of one or more of the text portions comprises sequentially inputting each of the items to the LLM.
